(19) United States
(12) Patent Application Publication
(10) Pub. No.: US 2018/0131184 A1
(43) Pub. Date: May 10, 2018

(54) POWER SUPPLY SYSTEM

(71) Applicant: Honda Motor Co.,Ltd., Tokyo (JP)

(72) Inventor: Ryota KITAMOTO, Saitama (JP)

(73) Assignee: Honda Motor Co.,Ltd., Tokyo (JP)

(21) Appl. No.: 15/800,080

(22) Filed: Nov. 1, 2017

(30) Foreign Application Priority Data
Nov. 4, 2016 (JP) 2016-216772

(51) Int. Cl. H02J 3/06; H02J 3/12; H02J 3/32

(52) U.S. Cl. CPC H02J 3/06; H02J 3/32; H02J 3/12

(57) ABSTRACT

A power supply system capable of achieving size reduction, weight reduction, or cost reduction while securing sufficient performance is provided. A voltage conversion unit (3) of a power supply system (A1) includes a plurality of voltage conversion parts (15a1 to 15b2) and is configured so that power of both a first power supply (1) and a second power supply (2) can be input to the voltage conversion parts (15b1 and 15b2), and the first power supply (1) can input power to a larger number of voltage conversion parts (15a1, 15a2, 15b1, and 15b2) than the second power supply (2).

This application claims the priority benefit of Japan application serial no. 2016-216772, filed on Nov. 4, 2016. The entirety of the above-mentioned patent application is hereby incorporated by reference herein and made a part of this specification.

### BACKGROUND OF THE INVENTION

### Field of the Invention

The present invention relates to a power supply system having two power supplies and a plurality of voltage conversion parts.

### Description of Related Art

Conventionally, as this kind of power supply system, for example, as disclosed in Patent Documents 1 to 3, one having a fuel cell and a rechargeable battery as two power supplies is generally known. In the system disclosed in Patent Documents 1 to 3, a converter configured to convert a voltage of the fuel cell and a converter configured to convert a voltage of the battery are included, and power is supplied to an electric load of an electric motor and the like via the converters.

In this case, the converter on the fuel cell side employs a multi-phase converter having a plurality of voltage conversion parts to enhance power transmission efficiency.

### CITATION LIST

### Patent Literature

[Patent Literature 1] Japanese Patent No. 5447520

[Patent Literature 2] Japanese Patent No. 5751329

[Patent Literature 3] Japanese Patent No. 5892367

### SUMMARY OF THE INVENTION

As disclosed in Patent Documents 1 to 3 above, in the conventional power supply system, a converter is provided for each of the two power supplies, and a multi-phase converter is used as a converter at one power supply (fuel cell) side.

Although such a power supply system can perform power control in various modes, a plurality of entire circuit components including a converter corresponding to each of the two power supplies are required. Because of this, the size, weight, or cost of the power supply system may increase, and it may be difficult to reduce them.

Further, because operating the converter corresponding to each of the two power supplies in a maximum output state is generally temporary, a period during which each of the converters is operated may be long in a state in which a sufficient power is remaining. Because of this, the cost performance of the power supply system may be low.

The present invention has been made in view of the above background, and it is an object of the present invention to provide a power supply system capable of achieving size reduction, weight reduction, or cost reduction while securing sufficient performance.

Another object of the present invention is to provide a transportation apparatus including the power supply system.

To achieve the above objects, a power supply system of the present invention includes a first power supply and a second power supply, and a voltage conversion unit having a first power input part and a second power input part to which power of the first power supply and power of the second power supply are respectively input and a plurality of voltage conversion parts each configured to input power of the first power supply or the second power supply from the first power input part or the second power input part and output power obtained by converting a voltage of the input power, the plurality of voltage conversion parts being connected in parallel to a common power output part so that the plurality of voltage conversion parts are able to output power from the power output part, wherein the voltage conversion unit is configured to be capable of inputting power of both the first power supply and the second power supply to one or more of the plurality of voltage conversion parts, and the first power supply is configured to be able to input power to a larger number of voltage conversion parts of the plurality of voltage conversion parts than the second power supply (a first aspect).

In the present invention, the phrase “capable of inputting power of both the first power supply and the second power supply” to any one of the plurality of voltage conversion parts means that, more specifically, each of the two powers can be input to the voltage conversion part at different timings or at the same time.

According to the first aspect, some (one or more) of the plurality of voltage conversion parts may be used as a voltage conversion part that converts voltages of a power of both the first power supply and the second power supply, that is, a common voltage conversion part for both the first power supply and the second power supply.

Further, because the first power supply is able to input power to a larger number of voltage conversion parts than the second power supply, the first power supply may transmit power to the power output part via a larger number of voltage conversion parts than the second power supply, and some (one or more) of the plurality of voltage conversion parts may be used as a voltage conversion part dedicated to the first power supply.

Because of this, the power of the first power supply may be transmitted in a wide range, and a voltage conversion part dedicated to the second power supply may be unnecessary or seldom needed.

Therefore, according to the power supply system of the first aspect, size reduction, weight reduction, or cost reduction can be achieved while securing sufficient performance.

In the first aspect, because the first power supply can input power to a larger number of voltage conversion parts than the second power supply, it is preferable to use power supplies with suitable characteristics and good compatibility with the power supply system of the present invention as the first power supply and the second power supply.

For example, it is preferable to use, as the first power supply and the second power supply, power supplies having different characteristics such that the first power supply has higher energy density than the second power supply and the second power supply has higher output density than the first power supply (a second aspect).

In the first aspect or the second aspect, more specifically, for example, a fuel cell may be employed as the first power supply, and an electric condenser may be employed as the second power supply (a third aspect).

According to the second aspect or the third aspect, power may be supplied to an external electric load by using the first power supply as a main power supply and the second power supply as an auxiliary power supply. As a result, power can be supplied to the electric load in a wide range while a period during which power can be supplied to the electric load is sufficiently lengthened.

In the first to third aspects, the voltage conversion unit may be configured so that power of the first power supply can be input from the first power input part to all of the plurality of voltage conversion parts (a fourth aspect).

According to this, although the number of voltage conversion parts dedicated to the second power supply becomes zero, the number (number of phases) of voltage conversion parts capable of converting a voltage of power of the first power supply is maximized. Because of this, an opportunity to use one or more voltage conversion parts capable of inputting power of both the first power supply and the second power supply as a voltage conversion part that inputs power of only the second power supply may be sufficiently secured.

Because all of voltage conversion parts not inputting the power of the second power supply among the plurality of voltage conversion parts can be used as voltage conversion parts dedicated to the second power supply, an opportunity to input power from the first power supply to a large number of voltage conversion parts can be sufficiently secured.

Therefore, according to the fourth aspect, size reduction, weight reduction, or cost reduction can be effectively achieved while securing sufficient performance of the power supply system.

In the first to fourth aspects, the voltage conversion unit may include one or more pairs of two voltage conversion parts respectively having two coils wound in opposite winding directions in a common core. In this case, it is preferable to be configured that a power supply capable of inputting power to one of the two voltage conversion parts of each pair and a power supply capable of inputting power to the other one match each other (a fifth aspect).

In the fifth aspect, the power supply capable of inputting power to one of the two voltage conversion parts of each pair (hereinafter, may be referred to as one side power supply) and the power supply capable of inputting power to the other (hereinafter, may be referred to as the other side power supply) may mean the first power supply, the second power supply, or both the first power supply and the second power supply. Also, the one side power supply and the other side power supply matching each other may mean any one of a case in which both the one side power supply and the other side power supply are the first power supply, a case in which both the one side power supply and the other side power supply are the second power supply, and a case in which both the one side power supply and the other side power supply are both the first power supply and the second power supply.

In a case in which the voltage conversion unit includes a plurality of the pairs of voltage conversion parts, power supplies corresponding to any one pair and power supplies corresponding to another pair may be either the same as each other or different from each other.

According to the fifth aspect, in a situation in which power is input to one of the two voltage conversion parts of each pair, power may also be input to the other voltage conversion part. Because of this, energization of a coil of one of the voltage conversion parts and energization of a coil of the other voltage conversion part may be performed in a well-balanced manner so as not to be biased to only one side.

Accordingly, a large amount of power can be efficiently transmitted by the two voltage conversion parts while preventing magnetic saturation of the core around which the coils of the two voltage conversion parts of each pair are wound. As a result, power transmission efficiency of the voltage conversion unit can be increased.

In the first to fifth aspects, the voltage conversion unit includes a first-A energization path configured to supply power from the first power input part to the voltage conversion part capable of inputting power of only the first power supply, a first-B energization path configured to supply power from the first power input part to the voltage conversion part capable of inputting power of both the first power supply and the second power supply, and a second energization path configured to supply power from the second power input part to the voltage conversion part capable of inputting power of the second power supply, wherein the first-B energization path may have a diode for blocking power transmission in a direction opposite to a direction toward the voltage conversion part capable of inputting power of both the first power supply and the second power supply from the first power input part and may be connected to the second energization path via the diode so that transmission of power of the second power supply to the first power input part side from the second energization path via the first-B energization path is blocked (a sixth aspect).

In the sixth aspect, “the voltage conversion part capable of inputting power of the second power supply” may mean, more specifically, a voltage conversion part capable of inputting power of only the second power supply or a voltage conversion part capable of inputting power of both the first power supply and the second power supply.

According to the sixth aspect, during operation of the voltage conversion part capable of inputting power of both the first power supply and the second power supply, power of the first power supply or the second power supply may be input to the voltage conversion part without any problems, and power of the second power supply being supplied to the voltage conversion part attempting to input power of only the first power supply or power of the second power supply being supplied to the first power supply side can be reliably prevented.

As a result, the voltage conversion part attempting to input power of only the first power supply and the voltage conversion part capable of inputting power of both the first power supply and the second power supply can be suitably operated with high reliability.

In the sixth aspect, it is preferable that the first-B energization path further have a switch element capable of blocking energization in the first-B energization path (a seventh aspect).

According to this, input of power from the first power supply to the voltage conversion part capable of inputting power of both the first power supply and the second power supply can be suitably and reliably blocked. As a result, suitably using the voltage conversion part as a voltage conversion part dedicated to the second power supply can be easily achieved.

In the first to seventh aspects, the first power supply may be a non-rechargeable power supply or a power supply prohibited from being charged from the power output part side via any one of the plurality of voltage conversion parts, and the second power supply may be a rechargeable power supply. In this case, it is preferable that the voltage conversion part capable of inputting power of only the first power supply be a one-way type voltage conversion part configured to transmit power in only one way from the first power input part side toward the power output part side, and the voltage conversion part capable of inputting power of the second power supply be a two-way type voltage conversion part configured to transmit power in two ways between the second power input part side and the power output part side (an eighth aspect).

In the eighth aspect, “the voltage conversion part capable of inputting power of the second power supply” may mean, more specifically, a voltage conversion part capable of inputting power of only the second power supply or a voltage conversion part capable of inputting power of both the first power supply and the second power supply.

According to this, because the voltage conversion part capable of inputting power of the second power supply is the two-way type voltage conversion part, charging power can be suitably supplied from the power output part to the second power supply.

Because the voltage conversion part capable of inputting power of only the first power supply is the one-way type voltage conversion part, the voltage conversion part has a simpler configuration with a smaller number of components than the two-way type voltage conversion part that serves as the voltage conversion part capable of inputting power of the second power supply.

Therefore, a power supply system capable of charging the second power supply from the outside can be achieved with a small-sized, lightweight, or low-cost configuration.

The eighth aspect is suitable in a case in which the power output part is connected to an electric motor capable of outputting regenerative power (a ninth aspect).

According to this, during regenerative operation of the electric motor, the regenerative power output from the electric motor can be charged to the second power supply.

The transportation apparatus of the present invention may include the power supply system according to any one of the first to ninth aspects (a tenth invention).

According to this, a transportation apparatus capable of exhibiting the effects described with respect to the first to ninth aspects can be achieved.

### BRIEF DESCRIPTION OF THE DRAWINGS

FIG. 1 is a view illustrating a configuration of a power supply system according to an embodiment of the present invention.

FIGS. 2A and 2B are views illustrating circuit configurations of voltage conversion parts included in the power supply system according to the embodiment.

FIG. 3A is a time chart illustrating a switching control operation of switch elements of two voltage conversion parts of the power supply system according to the embodiment, and FIG. 3B is a time chart illustrating a switching control operation of switch elements of four voltage conversion parts of the power supply system according to the embodiment.

FIG. 4 is a view schematically illustrating a power transmission mode in a first control process.

FIG. 5 is a view schematically illustrating a power transmission mode in a second control process.

FIG. 6 is a view schematically illustrating a power transmission mode in a third control process.

FIG. 7 is a view schematically illustrating a power transmission mode in a fourth control process.

FIG. 8 is a view schematically illustrating a power transmission mode in a fifth-a control process including the third control process.

FIG. 9 is a view schematically illustrating a power transmission mode in a fifth-b control process including the fourth control process.

FIG. 10 is a view schematically illustrating a power transmission mode in a sixth-a control process including the third control process.

FIG. 11 is a view schematically illustrating a power transmission mode in a sixth-b control process including the fourth control process.

### DESCRIPTION OF THE EMBODIMENTS

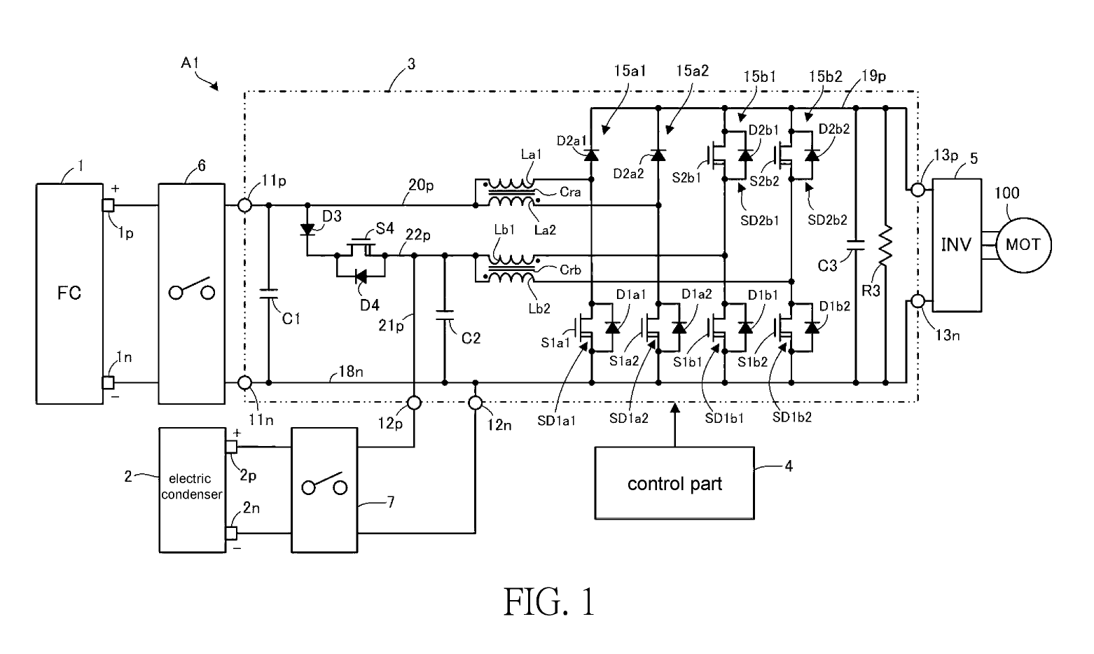

Embodiments of the present invention will be described with reference to FIGS. 1 to 11. As illustrated in FIG. 1, a power supply system A1 according to the present embodiment includes a first power supply 1, a second power supply 2, a voltage conversion unit 3, and a control part 4 and is configured so that power can be supplied from each of the first power supply 1 and the second power supply 2 to an electric load 100 via the voltage conversion unit 3. The voltage conversion unit 3 may be controlled by the control part 4 such that it outputs power (DC power) obtained by converting a voltage of power (DC power) input from each of the first power supply 1 and the second power supply 2.

The power supply system A1 is, for example, embedded in a transportation apparatus (for example, an electric vehicle or a hybrid vehicle) having an electric motor as the electric load 100. The DC power output from the voltage conversion unit 3 is converted into AC power via an inverter 5 and then supplied to the electric load 100 (hereinafter, referred to as the electric motor 100).

The electric motor 100 can perform regenerative operation, and during the regenerative operation, regenerative power (AC power) output from the electric motor 100 is converted into DC power by the inverter 5 and then input to the voltage conversion unit 3.

The first power supply 1 and the second power supply 2 are power supplies having different characteristics. Specifically, the first power supply 1 is a power supply having higher energy density than the second power supply 2. More specifically, the energy density is the total amount of electrical energy that a unit weight or unit volume of the power supply can output. In the present embodiment, the first power supply 1 is, for example, a fuel cell.

Positive-electrode and negative-electrode output terminal parts 1p and 1n of the first power supply 1 are connected to a pair of first input terminal parts 11p and 11n, which serve as the first power input parts of the voltage conversion unit 3, via a contactor 6. In an on-state of the contactor 6, because the output terminal parts 1p and 1n of the first power supply 1 are respectively electrically connected to the first input terminal parts 11p and 11n, an output voltage of the first power supply 1 is applied between the first input terminal parts 11p and 11n.

The second power supply 2 is a power supply having higher output density than the first power supply 1. The output density is the amount of electricity (the amount of electrical energy per unit time or the amount of charge per unit time) that a unit weight or unit volume of the power supply can output per unit time. In the present embodiment, the second power supply 2 is configured by, for example, a secondary battery such as a lithium ion battery and a nickel hydride battery or a rechargeable electric condenser such as a capacitor.

Positive-electrode and negative-electrode output terminal parts 2p and 2n of the second power supply 2 are connected to a pair of second input terminal parts 12p and 12n, which serve as the second power input parts of the voltage conversion unit 3, via a contactor 7. In an on-state of the contactor 7, because the output terminal parts 2p and 2n of the second power supply 2 are respectively electrically connected to the second input terminal parts 12p and 12n, an output voltage of the second power supply 2 is applied between the second input terminal parts 12p and 12n.

The negative-electrode side second input terminal part 12n of the second input terminal parts 12p and 12n may be a terminal part common to the negative-electrode side first input terminal part 11n of the first input terminal parts 11p and 11n.

The voltage conversion unit 3 includes the first input terminal parts 11p and 11n, the second input terminal parts 12p and 12n, and a pair of output terminal parts 13p and 13n that serve as power output parts, and the electric motor 100 (electric load) is connected to the output terminal parts 13p and 13n via the inverter 5.

The negative-electrode side output terminal part 13n of the output terminal parts 13p and 13n may be a terminal part common to the negative-electrode side first input terminal part 11n of the first input terminal parts 11p and 11n or the negative-electrode side second input terminal part 12n of the second input terminal parts 12p and 12n.

The voltage conversion unit 3 is configured to generate and output power obtained by converting a voltage of power input from the first power supply 1 to the first input terminal parts 11p and 11n or power input from the second power supply 2 to the second input terminal parts 12p and 12n between the output terminal parts 13p and 13n.

More specifically, the voltage conversion unit 3 is a multi-phase DC/DC converter having a plurality of (four in the present embodiment) voltage conversion parts 15a1, 15a2, 15b1, and 15b2. In addition to the voltage conversion parts 15a1, 15a2, 15b1, and 15b2, the voltage conversion unit 3 includes a capacitor C1 connected between the first input terminal parts 11p and 11n, a capacitor C2 connected between the second input terminal parts 12p and 12n, a capacitor C3 and a resistor R3 connected in parallel between the output terminal parts 13p and 13n, and diodes D3, D4, and a switch element S4 interposed in an energization path 22p, which will be described below.

The capacitors C1 to C3 are capacitors that respectively smooth a voltage between the first input terminal parts 11p and 11n, a voltage between the second input terminal parts 12p and 12n, and a voltage between the output terminal parts 13p and 13n, and the resistor R3 is a discharging resistor of the capacitor C3.

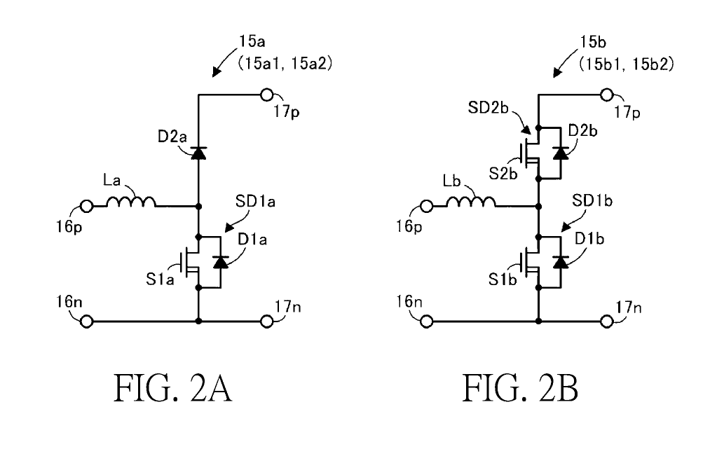

Each of the voltage conversion parts 15a1, 15a2, 15b1, and 15b2 is a switching type voltage conversion part (DC/DC converter) and is either a voltage conversion part 15a having a circuit configuration illustrated in FIG. 2A or a voltage conversion part 15b having a circuit configuration illustrated in FIG. 2B. In the present embodiment, of the four voltage conversion parts 15a1, 15a2, 15b1, and 15b2, the two voltage conversion parts 15a1 and 15a2 are voltage conversion parts 15a having the circuit configuration illustrated in FIG. 2A, and the other two voltage conversion parts 15b1 and 15b2 are voltage conversion parts 15b having the circuit configuration illustrated in FIG. 2B.

As illustrated in FIG. 2A, the voltage conversion part 15a (each of the voltage conversion parts 15a1 and 15a2) is a one-way type voltage conversion part that includes a coil La that serves as an inductor, a switch part SD1a formed by connecting a switch element S1a and a diode D1a in parallel, and a diode D2a and is configured to perform one-way power transmission and voltage conversion from first-side terminal parts 16p and 16n to second-side terminal parts 17p and 17n.

Specifically, one end of the coil La is connected to a high potential-side terminal part 16p of the first-side terminal parts 16p and 16n. The other side of the coil La is connected to reference potential-side terminal parts 16n and 17n at the first side and the second side, respectively, via the switch part SD1a and is connected to a high potential-side terminal part 17p of the second-side terminal parts 17p and 17n via the diode D2a.

The switch element S1a of the switch part SD1a is configured by, for example, a semiconductor switch element such as an insulated gate bipolar transistor (IGBT), a field effect transistor (FET), and a power transistor, and an energizing direction thereof is a direction from the other end of the coil La to the reference potential-side terminal parts 16n and 17n. A forward direction of the diode D1a is a direction opposite to the energizing direction of the switch element S1a, and a forward direction of the diode D2a is a direction from the other end of the coil La to the terminal part 17p.

The voltage conversion part 15a having the above configuration periodically turns on and off (switches) the switch element S1a, thereby outputting DC power from the second-side terminal parts 17p and 17n which is obtained by boosting a voltage of DC power input to the first-side terminal parts 16p and 16n. In this case, a boosting rate of the voltage may be variably controlled by adjusting an on/off duty of the switch element S1a.

When the switch element S1a is maintained in an off-state, with respect to one-way power transmission from the first side to the second side of the voltage conversion part 15a, the voltage conversion part 15a is in a state in which the first side and the second side of the voltage conversion part 15a are substantially directly coupled. In this state, the DC power input to the first-side terminal parts 16p and 16n can be output from the second-side terminal parts 17p and 17n without change (without converting a voltage).

As illustrated in FIG. 2B, the voltage conversion part 15b (each of the voltage conversion parts 15b1 and 15b2) is a two-way type voltage conversion part that includes a coil Lb that serves as an inductor, a switch part SD1b formed by connecting a switch element S1b and a diode D1b in parallel, and a switch part SD2b formed by connecting a switch element S2b and a diode D2b in parallel and is configured to perform two-way power transmission and voltage conversion between the first-side terminal parts 16p and 16n and the second-side terminal parts 17p and 17n.

Specifically, one end of the coil Lb is connected to a high potential-side terminal part 16p of the first-side terminal parts 16p and 16n. The other end of the coil Lb is connected to reference potential-side terminal parts 16n and 17n at the first side and the second side, respectively, via the switch part SD1b and is connected to a high potential-side terminal part 17p of the second-side terminal parts 17p and 17n via the switch part SD2b.

The respective switch elements S1b and S2b of the switch parts SD1b and SD2b are configured by, for example, a semiconductor switch element such as an IGBT, an FET, and a power transistor. An energizing direction of the switch element S1b is a direction from the other end of the coil Lb to the terminal parts 16n and 17n, and an energizing direction of the switch element S2b is a direction from the terminal part 17b to the other end of the coil Lb. A forward direction of the diode D1b is a direction opposite to the energizing direction of the switch element S1b, and a forward direction of the diode D2b is a direction opposite to the energizing direction of the switch element S2b.

The voltage conversion part 15b having the above configuration periodically turns on and off (switches) the switch element S1b, thereby like the voltage conversion part 15a, the voltage conversion part 15b is capable of outputting DC power from the second-side terminal parts 17p and 17n which is obtained by boosting a voltage of DC power input to the first-side terminal parts 16p and 16n. In this case, a boosting rate of the voltage may be variably controlled by adjusting the on/off duty of the switch element S1b.

For example, by periodically tuning on and off (switching) the switch element S1b in a state in which the switch element S2b is controlled such that it is in an on-state, DC power obtained by dropping a voltage of DC power input to the second-side terminal parts 17p and 17n (for example, DC power generated from the regenerative power of the electric motor 100 via the inverter 5) may be output from the first-side terminal parts 16p and 16n. In this case, a dropping rate of the voltage may be variably controlled by adjusting the on/off duty of the switch element S1b.

In the boosting operation or the dropping operation of the voltage conversion part 15b, switching of both of the switch elements S1b and S2b may be periodically performed so that the switch elements S1b and S2b are alternately turned on (alternately turned off).

When the switch elements S1b and S2b are maintained in an off-state, with respect to one-way power transmission from the first side to the second side of the voltage conversion part 15b, the voltage conversion part 15b is in a state in which the first side and the second side of the voltage conversion part 15b are substantially directly coupled. In this state, like the voltage conversion part 15a, the DC power input to the first-side terminal parts 16p and 16n can be output from the second-side terminal parts 17p and 17n without change (without converting a voltage).

When the switch element S1b is maintained in an off-state and the switch element S2b is maintained in an on-state, with respect to two-way power transmission between the first side and the second side of the voltage conversion part 15b, the voltage conversion part 15b is in a state in which the first side and the second side of the voltage conversion part 15b are substantially directly coupled. In this state, DC power input to one sides of the first-side terminal parts 16p and 16n and the second-side terminal parts 17p and 17n can be output from the other sides without change (without converting a voltage).

In the present embodiment, the four voltage conversion parts 15a1, 15a2, 15b1, and 15b2 configured as above are incorporated in the voltage conversion unit 3 in the connection form of FIG. 1.

In FIG. 1, to differentiate elements of the two voltage conversion parts 15a (15a1 and 15a2) having the circuit configuration illustrated in FIG. 2A, “1” is attached to an end of reference symbols of an element of the voltage conversion part 15a1, and “2” is attached to an end of a reference symbol of an element of the voltage conversion part 15a2. For example, reference symbols D2a1 and D2a2 are respectively attached to the diodes D2a of the voltage conversion parts 15a1 and 15a2.

Likewise, in FIG. 1, to differentiate elements of the two voltage conversion parts 15b (15b1 and 15b2) having the circuit configuration illustrated in FIG. 2B, “1” is attached to an end of a reference symbol of an element of the voltage conversion part 15b1, and “2” is attached to an end of a reference symbol of an element of the voltage conversion part 15b2.

In FIG. 1, the first-side terminal parts 16p and 16n and the second-side terminal parts 17p and 17n of each of the voltage conversion parts 15a1, 15a2, 15b1, and 15b2 are not illustrated.

Referring to FIG. 1, the reference potential-side terminal parts 16n and 17n (not illustrated) of each of the four voltage conversion parts 15a1, 15a2, 15b1, and 15b2 are connected to the negative electrode-side first input terminal part 11n, second input terminal part 12n, and output terminal part 13n at the same potential via a common wiring line 18n (reference potential line).

The high potential-side terminal part 17p (not illustrated) at the second side of each of the four voltage conversion parts 15a1, 15a2, 15b1, and 15b2 is connected to the positive electrode-side output terminal part 13p at the same potential via a common wiring line 19p.

The high potential-side terminal part 16p (not illustrated) at the first side of each of the two voltage conversion parts 15a1 and 15a2 having the circuit configuration illustrated in FIG. 2A is connected to the positive electrode-side first input terminal part 11p at the same potential via a common wiring line 20p. The wiring line 20p corresponds to the first-A energization path in the present invention.

The voltage conversion parts 15a1 and 15a2 are formed as a pair having a common core around which respective coils La1 and La2 are wound. That is, the coil La1 of the voltage conversion part 15a1 and the coil La2 of the voltage conversion part 15a2 are wound around a common core Cra. In this case, the coils La1 and La2 are wound around the core Cra in winding directions opposite to each other so that magnetic fluxes generated due to mutual induction during energization to the coils La1 and La2 are magnetic fluxes in directions opposite to each other.

The high potential-side terminal part 16p (not illustrated) at the first side of each of the two voltage conversion parts 15b1 and 15b2 having the circuit configuration illustrated in FIG. 2B is connected to the positive electrode-side second input terminal part 12p at the same potential via a common wiring line 21p and is connected to the positive electrode-side first input terminal part 11p via the energization path 22p having the diodes D3, D4 and the switch element S4. The wiring line 21p corresponds to the second energization path in the present invention, and the energization path 22p corresponds to the first-B energization path in the present invention.

The voltage conversion parts 15b1 and 15b2 are formed as a pair having a common core around which respective coils Lb1 and Lb2 are wound. That is, the coil Lb1 of the voltage conversion part 15b1 and the coil Lb2 of the voltage conversion part 15b2 are wound around a common core Crb. In this case, the coils Lb1 and Lb2 are wound around the core Crb in winding directions opposite to each other so that magnetic fluxes generated due to mutual induction during energization to the coils Lb1 and Lb2 are magnetic fluxes in directions opposite to each other.

The switch element S4 included in the energization path 22p is configured by a semiconductor switch element such as an IGBT, an FET, and a power transistor. In the energization path 22p, the diode D3 is connected in series to the switch element S4, and the diode D4 is connected in parallel to the switch element S4. In this case, an energizing direction of the switch element S4 and a forward direction of the diode D3 are a direction from the first input terminal part 11p to the voltage conversion parts 15b1 and 15b2. A forward direction of the diode D4 is a direction opposite to the energizing direction of the switch element S4.

Because the switch element S4 and the diodes D3, D4 are interposed in the energization path 22p as described above, the second input terminal part 12p is connected to the first input terminal part 11p and the wiring line 20p via the wiring line 21p and the energization path 22p.

Because the energization path 22p is blocked in an off-state of the switch element S4 of the energization path 22p, the second input terminal part 12p and the first sides of the voltage conversion parts 15a1 and 15a2 are electrically separated from the first input terminal part 11p and the wiring line 20p. In this state, power transmission cannot be performed in any direction between the first power supply 1 or the first sides of the voltage conversion parts 15a1 and 15a2 and the second power supply 2 or the first sides of the voltage conversion parts 15b1 and 15b2.

In an on-state of the switch element S4, energization is allowed in the forward direction of the diode D3 in the energization path 22p while energization in a direction opposite thereto is blocked. Because of this, although energization from the first input terminal part 11b or the wiring line 20p to the second input terminal part 12p or the first sides of the voltage conversion parts 15b1 and 15b2 is allowed, energization in a direction opposite thereto is blocked by the diode D3. As a result, although power transmission from the first power supply 1 to the second power supply 2 or the first sides of the voltage conversion parts 15b1 and 15b2 via the energization path 22p is allowed, power transmission from the second power supply 2 or the first sides of the voltage conversion parts 15b1 and 15b2 to the first power supply 1 or the first sides of the voltage conversion parts 15a1 and 15a2 is blocked by the diode D3.

Therefore, regardless of the on/off state of the switch element S4, power transmission from the second power supply 2 or the first sides of the voltage conversion parts 15b1 and 15b2 to the first power supply 1 or the first sides of the voltage conversion parts 15a1 and 15a2 is impossible.

Because the voltage conversion parts 15a1, 15a2, 15b1, and 15b2 are connected to each other as described above, the second sides (load sides) of the voltage conversion parts 15a1, 15a2, 15b1, and 15b2 are connected in parallel to the output terminal parts 13p and 13n.

The first sides (power supply sides) of the voltage conversion parts 15a1 and 15a2 having the circuit configuration illustrated in FIG. 2A are respectively connected in parallel to the first input terminal parts 11p and 11n, and the first sides (power supply sides) of the voltage conversion parts 15b1 and 15b2 having the circuit configuration illustrated in FIG. 2B are respectively connected in parallel to the second input terminal parts 12p and 12n.

In the on-state of the switch element S4, the first sides of the voltage conversion parts 15b1 and 15b2, in addition to the voltage conversion parts 15a1 and 15a2, are respectively connected in parallel to the first input terminal parts 11p and 11n so that power of the first power supply 1 can be input.

The voltage conversion unit 3 of the present embodiment is configured as described above. Because of this, power of the first power supply 1 can be input to each of the four voltage conversion parts 15a1, 15a2, 15b1, and 15b2. Therefore, the voltage conversion unit 3 may serve as a DC/DC converter having a four-phase configuration for the first power supply 1.

In the following description, the voltage conversion parts 15a1, 15a2, 15b1, and 15b2 may be respectively referred to as a first-phase voltage conversion part 15a1, a second-phase voltage conversion part 15a2, a third-phase voltage conversion part 15b1, and a fourth-phase voltage conversion part 15b2 in that order in some cases.

Inputting power from the first power supply 1 to the third-phase voltage conversion part 15b1 and the fourth-phase voltage conversion part 15b2 is possible by controlling the switch element S4 of the energization path 22p such that it is in the on-state in a situation in which an output voltage of the first power supply 1 is set to be higher than an output voltage of the second power supply 2.

Power of the second power supply 2 cannot be input to the first-phase voltage conversion part 15a1 and the second-phase voltage conversion part 15a2 and can be input only to the third-phase voltage conversion part 15b1 and the fourth-phase voltage conversion part 15b2. Therefore, the voltage conversion unit 3 is configured to serve as a DC/DC converter having a two-phase configuration for the second power supply 2.

In this way, of the first-phase voltage conversion part 15a1, the second-phase voltage conversion part 15a2, the third-phase voltage conversion part 15b1, and the fourth-phase voltage conversion part 15b2, the third-phase voltage conversion part 15b1 and the fourth-phase voltage conversion part 15b2 are voltage conversion parts capable of inputting power of both the first power supply 1 and the second power supply 2 (that is, a common voltage conversion part for the first power supply 1 and the second power supply 2), and the first-phase voltage conversion part 15a1 and the second-phase voltage conversion part 15a2 are voltage conversion parts capable of inputting power of only the first power supply 1 (that is, a voltage conversion part dedicated to the first power supply 1).

In this case, in the pair of the first-phase voltage conversion part 15a1 and the second-phase voltage conversion part 15a2 respectively having the coils La1 and La2 wound around the common core Cra, power supplies capable of inputting power to the first-phase voltage conversion part 15a1 and the second-phase voltage conversion part 15a2 match each other (in the present embodiment, only the first power supply 1).

Likewise, with respect to the pair of the third-phase voltage conversion part 15b1 and the fourth-phase voltage conversion part 15b2 respectively having the coils Lb1 and Lb2 wound around the common core Crb, power supplies capable of inputting power to the third-phase voltage conversion part 15b1 and the fourth-phase voltage conversion part 15b2 match each other (in the present embodiment, both the first power supply 1 and the second power supply 2).

Because the third-phase voltage conversion part 15b1 and the fourth-phase voltage conversion part 15b2 respectively have switch elements S2b1 and S2b2 between the coils Lb1, Lb2 and the output terminal part 13p, during the regenerative operation of the electric motor 100, the second power supply 2 may be charged by supplying power from the output terminal parts 13p and 13n to the second power supply 2, which is an electric condenser, via the voltage conversion part 15b1 or 15b2.

Alternatively, power of the first power supply 1 may be charged to the second power supply 2 via the first-phase voltage conversion part 15a1 or the second-phase voltage conversion part 15a2 and the third-phase voltage conversion part 15b1 or the fourth-phase voltage conversion part 15b2.

In the on-state of the switch element S4 of the energization path 22p, because the first input terminal part 11p is electrically connected to the second input terminal part 12p via the energization path 22p in the forward direction of the diode D3, power of the first power supply 1 may be charged to the second power supply 2 directly (without going via the voltage conversion parts 15a1, 15a2, 15b1, and 15b2) via the energization path 22p in a situation in which the output voltage of the first power supply 1 is set to be higher than the output voltage of the second power supply 2.

The voltage conversion part 15b having the circuit configuration illustrated in FIG. 2B may be used as the first-phase voltage conversion part 15a1 and the second-phase voltage conversion part 15a2 that are dedicated to the first power supply 1.

Because the first power supply 1 is a non-rechargeable power supply, the switch element S2 is unnecessary. Because of this, in the present embodiment, for size reduction, weight reduction, or cost reduction of the voltage conversion unit 3, the voltage conversion part 15a having the circuit configuration illustrated in FIG. 2A is employed as the voltage conversion parts 15a1 and 15a2 dedicated to the first power supply 1.

In the present embodiment, the voltage conversion unit 3 is configured as described above.

In addition, the voltage conversion unit 3 is not limited to having a single structure and may be configured by connecting a plurality of units to each other.

Although the capacitors C1 to C3 and the resistor R3 are included in the voltage conversion unit 3 in the present embodiment, the capacitors C1 to C3 and the resistor R3 may also be considered as elements not included in the voltage conversion unit 3.

The contactors 6 and 7 may not be considered as elements of the voltage conversion unit 3.

The control part 4 may be configured by one or more electronic circuit units including a central processing unit (CPU), a random access memory (RAM), a read-only memory (ROM), an interface circuit, and the like. The control part 4 has a function of performing operational control for the voltage conversion unit 3 (specifically, on/off control of the switch elements S1a1, S1a2, S1b1, S1b2, S2b1, S2b2, and S4) via hardware components mounted therein or programs (software configuration).

Various operations of the power supply system A1 of the present embodiment are achieved by a control process of the control part 4. Hereinafter, the control process performed by the control part 4 will be described. In the following description, the power supply system A1 of the present embodiment is, for example, embedded in an electric vehicle (hereinafter, simply referred to as “vehicle”) that travels with the electric motor 100 as a power source. In the following description, Vfc and Vbat will be respectively used as reference symbol for the output voltage of the first power supply 1 and the output voltage of the second power supply 2.

The control part 4 performs control processes (first to sixth-b control processes) shown in Table 1 below in a state in which the contactors 6 and 7 are in an on-state (a state in which the vehicle can travel).

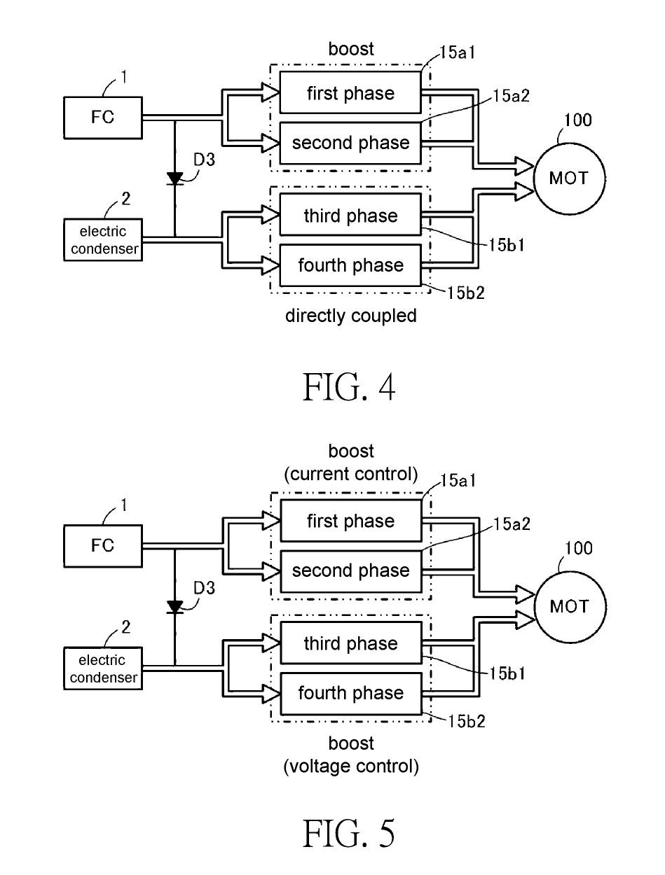

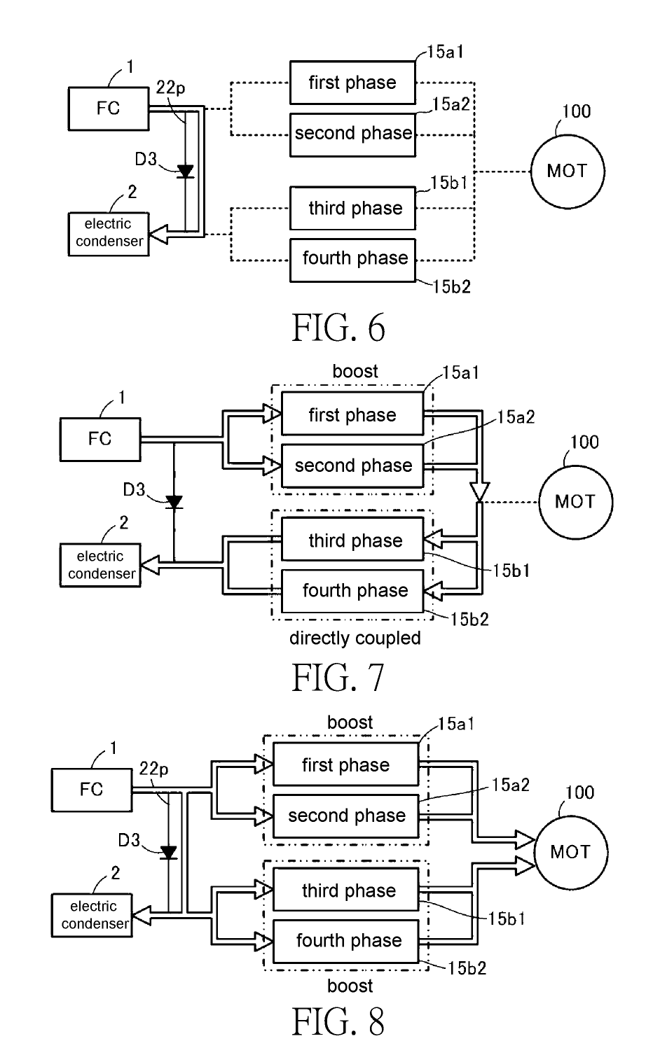

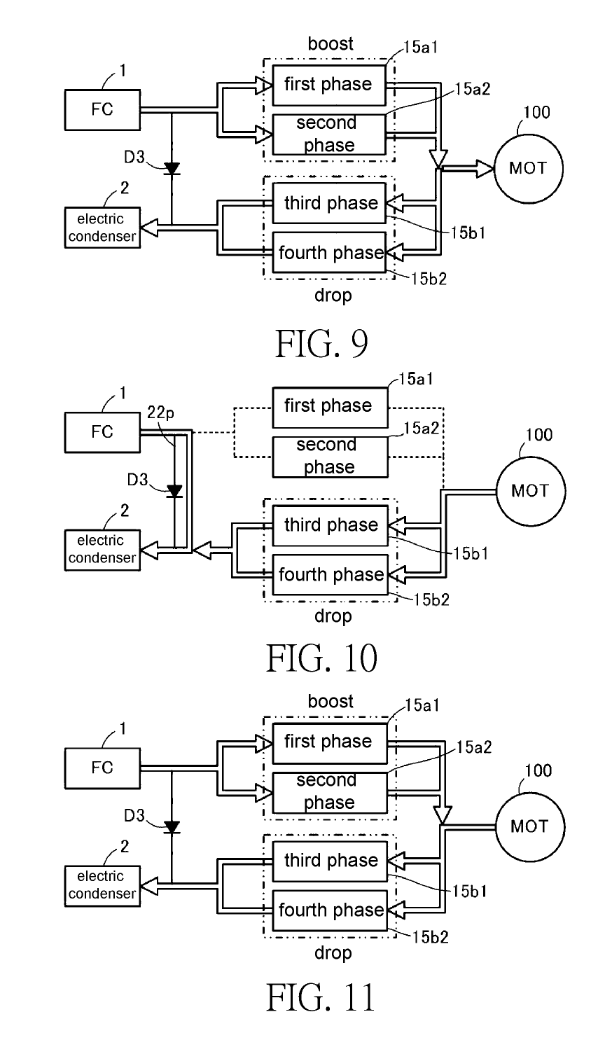

TABLE 1

| Control | | Vehicle state | State of switch | Corresponding |
|---|---|---|---|---|
| process | Control state | (example) | element S4 | drawing |
| First control | Power-run | Accelerating or | Off or on | FIG. 4 |
| process | (Driving force: small) | cruising | | |
| Second control | Power-run | Accelerating or | Off or On | FIG. 5 |
| process | (Driving force: large) | high load operation | | |
| Third control | Directly charge | At a stop | On | FIG. 6 |
| process | second power supply | | | |
| Fourth control | Charge second power | At a stop | Off | FIG. 7 |
| process | supply using voltage | | (or On (when | |
| | conversion part | | Vfc < Vbat)) | |
| Fifth-a control | Power-run and | Accelerating or | On | FIG. 8 |
| process | directly charge | cruising | | |
| | second power supply | | | |
| Fifth-b control | Power-run and charge | Accelerating or | Off | FIG. 9 |
| process | second power supply | cruising | (or On (when | |
| | using voltage | | Vfc < Vbat)) | |
| | conversion part | | | |
| Sixth-a control | Regenerate and | Regenerative | On | FIG. 10 |
| process | directly charge | braking | | |
| | second power supply | | | |
| Sixth-b control | Regenerate and | Regenerative | Off | FIG. 11 |
| process | charge second power | braking | (or On (when | |
| | supply using voltage | | Vfc < Vbat)) | |
| | conversion part | | | |

Hereinafter, the control processes will be described.

(First Control Process)

The first control process is a control process in which a relatively small driving force is caused to be generated in the electric motor 100 while power of both the first power supply 1 and the second power supply 2 (mainly, power of the first power supply 1) is supplied to the electric motor 100 as illustrated in FIG. 4 when the output voltage Vbat of the second power supply 2 is set to be higher than the output voltage Vfc of the first power supply 1 during power-run operation of the electric motor 100.

For example, the first control process is a control process performed during power-run operation in which a driving force to be generated in the electric motor 100 is relatively small, such as a situation in which a required acceleration (a required value of a rotational angular acceleration of an output shaft of the electric motor 100) or a required driving force of the electric motor 100 is smaller than a predetermined threshold value, or a cruising operation state of the electric motor 100 in a low speed range in which an operating speed of the electric motor 100 (a rotational angular velocity of the output shaft of the electric motor 100) is lower than a predetermined threshold value.

The situation in which the required acceleration or required driving force of the electric motor 100 is smaller than the predetermined threshold value is, in other words, a situation in which a required acceleration or required driving force (required propulsion force) of a vehicle is smaller than a predetermined threshold value (a slow acceleration situation of the vehicle).

The cruising operation state of the electric motor 100 is an operation state in which the rotational angular velocity of the output shaft of the electric motor 100 is kept substantially constant. The cruising operation state of the electric motor 100 in a low speed range in which the operating speed of the electric motor 100 is lower than the predetermined threshold value is, in other words, a cruising traveling state of the vehicle in a low speed range in which a vehicle speed is lower than the predetermined threshold value.

The first control process is performed as follows. That is, in a situation in which the output voltage Vbat of the second power supply 2 is set to be higher than the output voltage Vfc of the first power supply 1, the control part 4 maintains the switch elements S1b1, S1b2 and the switch elements S2b1, S2b2 of the third-phase voltage conversion part 15b1 and the fourth-phase voltage conversion part 15b2 in an off-state. The switch element S4 of the energization path 22p may be in either one of an on-state or an off-state.

Consequently, each of the third-phase voltage conversion part 15b1 and the fourth-phase voltage conversion part 15b2 reaches a directly coupled state in which power of the second power supply 2 input to the first side is output to the second side without change (without converting a voltage). Because of this, an output voltage (second-side voltage) of each of the third-phase voltage conversion part 15b1 and the fourth-phase voltage conversion part 15b2, and eventually voltages generated by the power output parts 13p and 13n, become a voltage that substantially matches the output voltage of the second power supply 2.

The control part 4 performs boosting operations of the first-phase voltage conversion part 15a1 and the second-phase voltage conversion part 15a2 so that an output voltage (second-side voltage) of each of the first-phase voltage conversion part 15a1 and the second-phase voltage conversion part 15a2 to which power of the first power supply 1 is input matches an output voltage (≈ the output voltage of the second power supply 2) of each of the third-phase voltage conversion part 15b1 and the fourth-phase voltage conversion part 15b2.

In the boosting operation, switching (turning on/off) of the respective switch elements S1a1 and S1a2 of the voltage conversion parts 15a1 and 15a2 is periodically performed, and output voltages of the voltage conversion parts 15a1 and 15a2 are controlled by adjusting the duty of the switching.

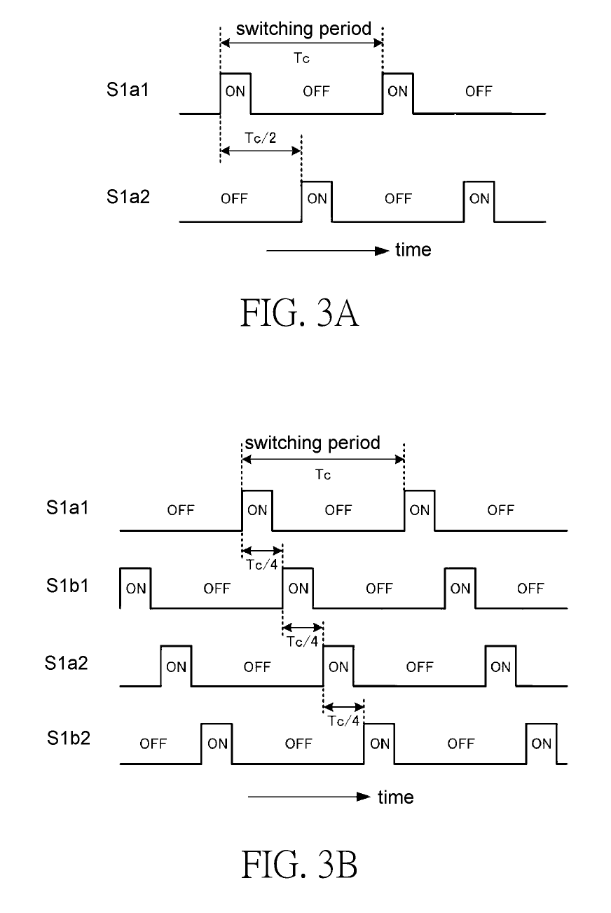

In this case, switching of the respective switch elements S1a1 and S1a2 of the voltage conversion parts 15a1 and 15a2 is performed so that, for example, as illustrated in FIG. 3A, a timing at which each of the switch elements S1a1 and S1a2 is turned on (or off) is shifted according to a phase (that is, a phase in 180 degrees) corresponding to a time width (=Tc/2) obtained by dividing a switching period Tc by the number of switch elements S1a1 and S1a2 (=2).

In this way, the ripple of the output voltages of the voltage conversion parts 15a1 and 15a2 may be reduced.

In the first control process, by operating the voltage conversion unit 3 as above, as illustrated in FIG. 4, power is supplied to the electric motor 100 from both the first power supply 1 and the second power supply 2 while the boosting operations of the first-phase voltage conversion part 15a1 and the second-phase voltage conversion part 15a2 are performed, and the power-run operation (power-run operation with a relatively small driving force) of the electric motor 100 is performed.

In this case, power of the first power supply 1 (fuel cell) may be mainly supplied to the electric motor 100, and power of the second power supply 2 (electric condenser) may be auxiliarily supplied to the electric motor 100 to supplement shortage of power of the first power supply 1.

When an energizing current to the electric motor 100 is sufficiently low, the boosting operation may be performed in only one of the voltage conversion parts 15a1 and 15a2.

Switching control of the switch elements S1b1 and S2b2 of the third-phase voltage conversion part 15b1 and the fourth-phase voltage conversion part 15b2 may be performed to control second-side voltages generated at the output terminal parts 13p and 13n (input voltages to the inverter 5) such that they are optimal voltages for efficiently operating the electric motor 100.

(Second Control Process)

The second control process is a control process in which a relatively large driving force is caused to be generated in the electric motor 100 while relatively large power is supplied to the electric motor 100 from both the first power supply 1 and the second power supply 2 during the power-run operation of the electric motor 100 as illustrated in FIG. 5.

For example, the second control process is a control process performed in a situation in which a required acceleration or required driving force of the electric motor 100 is larger than a predetermined threshold value (threshold value close to a maximum value) (a situation in which power-run operation is performed to cause a relatively large driving force to be generated in the electric motor 100).

The situation in which the required acceleration or required driving force of the electric motor 100 is larger than the predetermined threshold value is, in other words, a situation in which a required acceleration or required driving force (required propulsion force) of the vehicle is larger than a predetermined threshold value (a rapid acceleration situation of the vehicle).

The second control process is performed as follows. That is, the control part 4 performs a boosting operation of each of the first-phase voltage conversion part 15a1, the second-phase voltage conversion part 15a2, the third-phase voltage conversion part 15b1, and the fourth-phase voltage conversion part 15b2 in a state in which the switch element S4 of the energization path 22p is controlled to be in an on-state.

In this case, the control part 4 performs a feedback control process so that an output voltage (second-side voltage) of each of the third-phase voltage conversion part 15b1 and the fourth-phase voltage conversion part 15b2, to which power of the second power supply 2, which is an electric condenser, is input is made to be close to a predetermined target value, thereby determining the duty of switching of the respective switch elements S1b1 and S1b2 of the voltage conversion parts 15b1 and 15b2. Switching (turning on/off) of each of the switch elements S1b1 and S1b2 is performed according to the duty.

Consequently, boosting operations of the voltage conversion parts 15b1 and 15b2 are performed by feedback control of voltage control.

The control part 4 performs a feedback control process so that an output voltage of each of the first-phase voltage conversion part 15a1 and the second-phase voltage conversion part 15a2, to which power of the first power supply 1, which is a fuel cell, is input is made to be close to a predetermined target value (for example, a current amount obtained by subtracting a total output current of the third-phase voltage conversion part 15b1 and the fourth-phase voltage conversion part 15b2 from a required current value of the electric motor 100), thereby determining the duty of switching (turning on/off) of the respective switch elements S1a1 and S1a2 of the voltage conversion parts 15a1 and 15a2. Switching of each of the switch elements S1a1 and S1a2 is performed according to the duty.

Consequently, boosting operations of the voltage conversion parts 15a1 and 15a2 are performed by feedback control of current control.

Here, because the first power supply 1, which is a fuel cell, has a low sensitivity for change in voltage with respect to change in current in a state in which a relatively high current is output, current control is more suitable than voltage control in enhancing stability of boosting operations of the voltage conversion parts 15a1 and 15a2 to which power of the first power supply 1 is input.

Because of this, in the present embodiment, boosting operations of the first-phase voltage conversion part 15a1 and the second-phase voltage conversion part 15a2 to which power of the first power supply 1 is input are performed by current control, and boosting operations of the third-phase voltage conversion part 15b1 and the fourth-phase voltage conversion part 15b2 to which power of the second power supply 2 is input are performed by voltage control.

Switching of the respective switch elements S1a1, S1a2, S1b1, and S1b2 of the four voltage conversion parts, the first-phase voltage conversion part 15a1, the second-phase voltage conversion part 15a2, the third-phase voltage conversion part 15b1, and the fourth-phase voltage conversion part 15b2, is performed so that, for example, as illustrated in FIG. 3B, a timing at which each of the switch elements S1a1, S1b1, S1a2, and S1b2 is turned on (or off) is shifted sequentially (in the order of the first-phase, the second-phase, the third-phase, and the fourth-phase) as much as a phase (that is, a phase of 90 degrees) corresponding to a time width (=Tc/4) obtained by dividing a switching period Tc by the number of switch elements S1a1, S1b1, S1a2, and S1b2 (=4).

In this way, like the case of the first control process, the ripple of the output voltages of the voltage conversion parts 15a1, 15a2, 15b1, and 15b2 may be reduced.

In the second control process, by operating the voltage conversion unit 3 as above, as illustrated in FIG. 5, a large amount of power is supplied to the electric motor 100 from both the first power supply 1 and the second power supply 2 while the boosting operations of the first-phase voltage conversion part 15a1, the second-phase voltage conversion part 15a2, the third-phase voltage conversion part 15b1, and the fourth-phase voltage conversion part 15b2 are performed, and the power-run operation (power-run operation with a large driving force) of the electric motor 100 is performed.

In this case, by controlling the switch element S4 of the energization path 22p to be in an on-state, even when the output voltage of the second power supply 2 is dropped while the second control process is performed, power supplied from the first power supply 1 to the electric motor 100 via the third-phase voltage conversion part 15b1 and the fourth-phase voltage conversion part 15b2 may be secured. Further, power of the first power supply 1 may be charged to the second power supply 2.

The switch element S4 may be set to be in an off-state in a state in which the output voltage Vfc of the first power supply 1 is set to be higher than the output voltage Vbat of the second power supply 2.

(Third Control Process and Fourth Control Process)

In the present embodiment, because the second power supply 2 is an electric condenser with high output density, there is a concern that power of the second power supply 2 may be exhausted at an early stage when power of the second power supply 2 is frequently supplied to the electric motor 100.

Because of this, power of the first power supply 1 is suitably charged to the second power supply 2. The charging is performed by the third control process or the fourth control process.

The third control process is, for example, as illustrated in FIG. 6, a control process for charging the second power supply 2 in a situation in which the output voltage Vfc of the first power supply 1 is set to be higher than the output voltage Vbat of the second power supply 2.

In the third control process, the control part 4 maintains the switch element S4 of the energization path 22b in an on-state.

In this case, because the output voltage Vfc of the first power supply 1 is higher than the output voltage Vbat of the second power supply 2, power of the first power supply 1 is charged to the second power supply 2 via the energization path 22p as illustrated in FIG. 6. In this case, because power of the first power supply 1 can be charged to the second power supply 2 without going via the voltage conversion parts 15a1, 15a2, 15b1, and 15b2, power of the first power supply 1 can be charged to the second power supply 2 efficiently (with low loss).

In FIG. 6, a situation in which power of the first power supply 1 is charged to the second power supply 2 during a situation, such as when the vehicle is at a stop, in which power-run operation or regenerative operation of the electric motor 100 is not being performed (an operation stop state of the electric motor 100) is illustrated. However, as will be described below, the third control process may also be performed during the power-run operation or regenerative operation of the electric motor 100.

The fourth control process is, for example, as illustrated in FIG. 7, a control process for charging the second power supply 2 in a situation in which the output voltage Vbat of the second power supply 2 is set to be higher than the output voltage Vfc of the first power supply 1, i.e., a situation in which supply of power of the first power supply 1 to the second power supply 2 via the energization path 22p is blocked by the diode D3.

In this control process, the control part 4 performs the boosting operation of each of the first-phase voltage conversion part 15a1 and the second-phase voltage conversion part 15a2. In this case, for example, the control part 4 controls the duty of switching of the respective switch elements S1a1 and S1a2 of the voltage conversion parts 15a1 and 15a2 so that the output voltage (second-side voltage) of each of the first-phase voltage conversion part 15a1 and the second-phase voltage conversion part 15a2 becomes a voltage value that is slightly higher than the output voltage Vbat of the second power supply 2.

Like the case of the first control process, switching of the switch elements S1a1 and S1a2 is performed by shifting a phase as illustrated in FIG. 3A.

The control part 4 maintains the switch elements S1b1 and S1b2 of the third-phase voltage conversion part 15b1 and the fourth-phase voltage conversion part 15b2 in an off-state and maintains the switch elements S2b1 and S2b2 in an on-state. Consequently, each of the third-phase voltage conversion part 15b1 and the fourth-phase voltage conversion part 15b2 reaches a directly coupled state in which power input to the second side is output from the first side without change (without converting a voltage).

Because of this, as illustrated in FIG. 7, power of the first power supply 1 boosted by the boosting operations of the first-phase voltage conversion part 15a1 and the second-phase voltage conversion part 15a2 is transmitted from the second side to the first side of the third-phase voltage conversion part 15b1 and the fourth-phase voltage conversion part 15b2 and is charged to the second power supply 2 from the first side of the voltage conversion parts 15b1 and 15b2.

Like the case of FIG. 6, a situation in which power of the first power supply 1 is charged to the second power supply 2 during the operation stop state of the electric motor 100, such as when the vehicle is at a stop, is illustrated in FIG. 7. However, as will be described below, the fourth control process may also be performed during the power-run operation or regenerative operation of the electric motor 100.

As described above, in the situation in which the output voltage Vbat of the second power supply 2 is set to be higher than the output voltage Vfc of the first power supply 1, power of the first power supply 1 may be charged to the second power supply 2 sequentially via the first-phase voltage conversion part 15a1 and the second-phase voltage conversion part 15a2 and via the third-phase voltage conversion part 15b1 and the fourth-phase voltage conversion part 15b2.

In the fourth control process, the boosting operation may be performed in only one of the first-phase voltage conversion part 15a1 and the second-phase voltage conversion part 15a2 in a situation in which a charging current to the second power supply 2 is low.

In the fourth control process, the switch element S4 of the energization path 22p may be maintained in an off-state.

In the fourth control process, dropping operations (dropping operations in which a voltage of power input to the second side is dropped and transmitted to the first side) of the third-phase voltage conversion part 15b1 and the fourth-phase voltage conversion part 15b2 may be performed. In this case, it is preferable that switching of the respective switch elements S1b1 and S1b2 of the voltage conversion parts 15b1 and 15b2 be performed by shifting a phase with the same mode as that illustrated in FIG. 3A.

In addition, in a state in which the switch element S4 of the energization path 22p is maintained in an off-state in a situation in which the output voltage Vfc of the first power supply 1 is higher than the output voltage Vbat of the second power supply 2, power of the first power supply 1 may be charged to the second power supply 2 sequentially via the first-phase voltage conversion part 15a1 and the second-phase voltage conversion part 15a2 and via the third-phase voltage conversion part 15b1 and the fourth-phase voltage conversion part 15b2 (in other words, the second power supply 2 may be charged by the fourth control process).

However, to minimize power loss, the power of the first power supply 1 is preferably charged to the second power supply 2 via the energization path 22p by the third control process.

(Fifth-a Control Process and Fifth-b Control Process)

As illustrated in FIG. 8, the fifth-a control process is a control process that simultaneously performs supplying power of the first power supply 1 to the electric motor 100 and charging power of the first power supply 1 to the second power supply 2 by the third control process during power-run operation of the electric motor 100. As illustrated in FIG. 9, the fifth-b control process is a control process that simultaneously performs supplying power of the first power supply 1 to the electric motor 100 and charging power of the first power supply 1 to the second power supply 2 by the fourth control process during power-run operation of the electric motor 100.

For example, the fifth-a control process and the fifth-b control process are control processes performed in a situation in which a required acceleration or required driving force of the electric motor 100 is small, e.g., a cruising operation state of the electric motor 100 in a high speed range in which an operating speed of the electric motor 100 (rotational angular velocity of the output shaft of the electric motor 100) is higher than a predetermined threshold value.

The cruising operation state of the electric motor 100 in a high speed range in which the operating speed of the electric motor 100 (rotational angular velocity of the output shaft of the electric motor 100) is higher than the predetermined threshold value is, in other words, a cruising traveling state of the vehicle in a high speed range in which a vehicle speed is higher than a predetermined threshold value.

The fifth-a control process is performed as follows. That is, in a situation in which the output voltage of the first power supply 1 is set to be higher than the output voltage of the second power supply 2, the control part 4 performs the boosting operation of one or more voltage conversion parts of the voltage conversion parts 15a1, 15a2, 15b1, and 15b2 while charging power of the first power supply 1 to the second power supply 2 via the energization path 22p by the third control process, thereby supplying power of the first power supply 1 to the electric motor 100 via the voltage conversion parts.

In this case, to increase the number (number of phases) of the voltage conversion parts in which boosting operations are caused to be performed (hereinafter, referred to as voltage conversion parts subjected to the boosting operation) as the current to be supplied to the electric motor 100 increases, the control part 4 selects the voltage conversion parts subjected to boosting operations.

For example, when the current to be supplied to the electric motor 100 is relatively low, the control part 4 selects the pair of first-phase voltage conversion part 15a1 and second-phase voltage conversion part 15a2 or the pair of third-phase voltage conversion part 15b1 and fourth-phase voltage conversion part 15b2 as the voltage conversion parts subjected to the boosting operation, and when the current to be supplied to the electric motor 100 is relatively high, the control part 4 selects the first-phase voltage conversion part 15a1, the second-phase voltage conversion part 15a2, the third-phase voltage conversion part 15b1, and the fourth-phase voltage conversion part 15b2 as the voltage conversion parts subjected to the boosting operation.

The control part 4 controls the duty of switching of the respective switch elements S1a or S1b of the voltage conversion parts subjected to the boosting operation so that output voltages (second-side voltages) of the voltage conversion parts subjected to the boosting operation are predetermined voltages required for the power-run operation of the electric motor 100.

In this case, when the voltage conversion parts subjected to the boosting operation are the pair of first-phase voltage conversion part 15a1 and second-phase voltage conversion part 15a2 or the pair of third-phase voltage conversion part 15b1 and fourth-phase voltage conversion part 15b2, switching of the respective switch elements S1a1 and S1a2 or S1b1 and S1b2 is performed by shifting a phase in the mode illustrated in FIG. 3A. When the voltage conversion parts subjected to the boosting operation are the four voltage conversion parts, the first-phase voltage conversion part 15a1, the second-phase voltage conversion part 15a2, the third-phase voltage conversion part 15b1, and the fourth-phase voltage conversion part 15b2, switching of the respective switch elements S1a1, S1a2, S1b1, and S1b2 is performed by shifting a phase in the mode illustrated in FIG. 3B.

By performing the fifth-a control process including the third control process as described above, for example, as illustrated in FIG. 8, power of the first power supply 1 is supplied to the electric motor 100 via the voltage conversion parts subjected to the boosting operation (in the example illustrated in FIG. 8, the four voltage conversion parts, the first-phase voltage conversion part 15a1, the second-phase voltage conversion part 15a2, the third-phase voltage conversion part 15b1, and the fourth-phase voltage conversion part 15b2) while power of the first power supply 1 is charged to the second power supply 2 via the energization path 22p.

In addition, when the current to be supplied to the electric motor 100 is sufficiently low, only one voltage conversion part of any phase among the voltage conversion parts 15a1, 15a2, 15b1, and 15b2 may be selected as the voltage conversion part subjected to the boosting operation.

Alternatively, as the current to be supplied to the electric motor 100 is increased, the number (number of phases) of the voltage conversion parts subjected to the boosting operation may be increased by one at a time. However, it is preferable that the pair of voltage conversion parts 15a1 and 15a2 having the common core Cra or the pair of voltage conversion parts 15b1 and 15b2 having the common core Crb be selected together as far as possible.

The fifth-b control process is performed as follows. That is, in a situation in which the output voltage of the second power supply 2 is set to be higher than the output voltage of the first power supply 1, the control part 4 supplies power of the first power supply 1 to the electric motor 100 via the first-phase voltage conversion part 15a1 and the second-phase voltage conversion part 15a2 while charging power of the first power supply 1 to the second power supply 2 sequentially via the first-phase voltage conversion part 15a1 and the second-phase voltage conversion part 15a2 and via the third-phase voltage conversion part 15b1 and the fourth-phase voltage conversion part 15b2 by the fourth control process.

In this case, by the boosting operations of the first-phase voltage conversion part 15a1 and the second-phase voltage conversion part 15a2, the control part 4 controls the duty of switching of the respective switch elements S1a1 and S1a2 of the voltage conversion parts 15a1 and 15a2 so that output voltages (second-side voltages) of the voltage conversion parts 15a1 and 15a2 are predetermined voltages required for the power-run operation of the electric motor 100 at voltages higher than the output voltage Vbat of the second power supply 2.

Switching of the switch elements S1a1 and S1a2 is performed by shifting a phase in the mode illustrated in FIG. 3A.

In a state in which the respective switch elements S2b1 and S2b2 of the third-phase voltage conversion part 15b1 and the fourth-phase voltage conversion part 15b2 are maintained in an on-state, the control part 4 controls the duty of switching of the respective switch elements S1b1 and S1b2 of the voltage conversion parts 15b1 and 15b2 by the dropping operations of the voltage conversion parts 15b1 and 15b2 so that first-side output voltages of the voltage conversion parts 15b1 and 15b2 are voltages slightly higher than the output voltage of the second power supply 2.

Switching of the switch elements S1b1 and S1b2 is performed by shifting a phase in the mode illustrated in FIG. 3A.

By performing the fifth-b control process including the fourth control process as described above, as illustrated in FIG. 9, power of the first power supply 1 is supplied to the electric motor 100 via the first-phase voltage conversion part 15a1 and the second-phase voltage conversion part 15a2 while power of the first power supply 1 is charged to the second power supply 2 sequentially via the first-phase voltage conversion part 15a1 and the second-phase voltage conversion part 15a2 and via the third-phase voltage conversion part 15b1 and the fourth-phase voltage conversion part 15b2.

In addition, when the current to be supplied to the electric motor 100 is sufficiently low, the boosting operation may be performed in only one of the first-phase voltage conversion part 15a1 and the second-phase voltage conversion part 15a2, or the dropping operation may be performed in only one of the third-phase voltage conversion part 15b1 and the fourth-phase voltage conversion part 15b2.

By performing the fifth-a control process or the fifth-b control process as described above, power of the first power supply 1 may be charged to the second power supply 2 while power is supplied from the first power supply 1 to the electric motor 100. Because of this, exhaustion of power of the second power supply 2 can be prevented by charging the second power supply 2 in a situation in which the power-run operation of the electric motor 100 can be performed only by power of the first power supply 1.

(Sixth-a Control Process and Sixth-b Control Process)

As illustrated in FIG. 10, the sixth-a control process is a control process that simultaneously performs charging regenerative power output from the electric motor 100 to the second power supply 2, which is an electric condenser, and charging power of the first power supply 1 to the second power supply 2 by the third control process during regenerative operation of the electric motor 100 (regenerative braking of the vehicle). As illustrated in FIG. 11, the sixth-b control process is a control process that simultaneously performs charging regenerative power output from the electric motor 100 to the second power supply 2, which is an electric condenser, and charging power of the first power supply 1 to the second power supply 2 by the fourth control process during regenerative operation of the electric motor 100 (regenerative braking of the vehicle).

The sixth-a control process is performed as follows. That is, in a situation in which the output voltage Vfc of the first power supply 1 is set to be higher than the output voltage Vbat of the second power supply 2, the control part 4 performs the dropping operation of the third-phase voltage conversion part 15b1 and the fourth voltage conversion part 15b2 to which regenerative power of the electric motor 100 is input while charging power of the first power supply 1 to the second power supply 2 via the energization path 22p by the third control process, thereby charging regenerative power to the second power supply 2 via the voltage conversion parts 15b1 and 15b2.

In this case, the control part 4 maintains the respective switch elements S1a1 and S1a2 of the first-phase voltage conversion part 15a1 and the second-phase voltage conversion part 15b2 in an off-state.

In a state in which the respective switch elements S2b1 and S2b2 of the third-phase voltage conversion part 15b1 and the fourth voltage conversion part 15b2 are maintained in an on-state, the control part 4 controls the duty of switching of the respective switch elements S1b1 and S1b2 of the voltage conversion parts 15b1 and 15b2 by the dropping operations of the voltage conversion parts 15b1 and 15b2 so that first-side output voltages of the voltage conversion parts 15b1 and 15b2 are voltages substantially equal to the output voltage Vfc of the first power supply 1.

Switching of the switch elements S1b1 and S1b2 is performed by shifting a phase in the mode illustrated in FIG. 3A.

By performing the sixth-a control process including the third control process as described above, as illustrated in FIG. 10, regenerative power of the electric motor 100 is charged to the second power supply 2 via the third-phase voltage conversion part 15b1 and the fourth-phase voltage conversion part 15b2 while power of the first power supply 1 is charged to the second power supply 2 via the energization path 22p.

In addition, when a voltage of regenerative power input to the power output parts 13p and 13n is controlled such that it is a voltage substantially equal to the output voltage Vfc of the first power supply 1, by maintaining the respective switch elements S2b1 and S2b2 of the third-phase voltage conversion part 15b1 and the fourth-phase voltage conversion part 15b2 in an on-state and maintaining the switch elements S1b1 and S1b2 in an off-state, the voltage conversion parts 15b1 and 15b2 may be set to be in a directly coupled state.

The sixth-b control process is performed as follows. That is, in a situation in which the output voltage Vbat of the second power supply 2 is set to be higher than the output voltage Vfc of the first power supply 1, the control part 4 charges regenerative power of the electric motor 100 to the second power supply 2 via the third-phase voltage conversion part 15b1 and the fourth-phase voltage conversion part 15b2 while charging the first power supply 1 to the second power supply 2 sequentially via the first-phase voltage conversion part 15a1 and the second-phase voltage conversion part 15a2 and via the third-phase voltage conversion part 15b1 and the fourth-phase voltage conversion part 15b2 by the fourth control process.

In this case, by the boosting operations of the first-phase voltage conversion part 15a1 and the second-phase voltage conversion part 15a2, the control part 4 controls the duty of switching of the respective switch elements S1a1 and S1a2 of the voltage conversion parts 15a1 and 15a2 so that output voltages (second-side voltages) of the voltage conversion parts 15a1 and 15a2 are voltages substantially equal to a voltage of regenerative power (specifically, a voltage of the regenerative power input to the power output parts 13p and 13n from the electric motor 100 via the inverter 5).

Switching of the switch elements S1a1 and S1a2 is performed by shifting a phase in the mode illustrated in FIG. 3A.

In a state in which the respective switch elements S2b1 and S2b2 of the third-phase voltage conversion part 15b1 and the fourth-phase voltage conversion part 15b2 are maintained in an on-state, the control part 4 controls the duty of switching of the respective switch elements S1b1 and S1b2 of the voltage conversion parts 15b1 and 15b2 by the dropping operations of the voltage conversion parts 15b1 and 15b2 so that first-side output voltages of the voltage conversion parts 15b1 and 15b2 are voltages slightly higher than the output voltage Vbat of the second power supply 2.

Switching of the switch elements S1b1 and S1b2 is performed by shifting a phase in the mode illustrated in FIG. 3A.

In addition, when a voltage of regenerative power input to the power output parts 13p and 13n is controlled such that it is a voltage slightly higher than the output voltage Vbat of the second power supply 2, by maintaining the respective switch elements S2b1 and S2b2 of the third-phase voltage conversion part 15b1 and the fourth-phase voltage conversion part 15b2 in an on-state and maintaining the switch elements S1b1 and S1b2 in an off-state, the voltage conversion parts 15b1 and 15b2 may be set to be in a directly coupled state.

By performing the sixth-a control process or the sixth-b control process as described above, during regenerative operation of the electric motor 100, in addition to regenerative power, power of the first power supply 1 can be charged to the second power supply 2. As a result, power of the second power supply 2 can be recovered in a short time.

In addition, in the control processes of the voltage conversion unit 3 described above, when the switch element S4 is switched from an off-state to an on-state, an inrush current can be suppressed by performing the switching of the switch element S4 in a state in which the output voltage Vfc of the first power supply 1 is lower than the output voltage Vbat of the second power supply 2.

According to the above-described embodiment, the voltage conversion unit 3 is configured so that the third-phase voltage conversion part 15b1 and the fourth-phase voltage conversion part 15b2 among the first-phase voltage conversion part 15a1, the second-phase voltage conversion part 15a2, the third-phase voltage conversion part 15b1, and the fourth-phase voltage conversion part 15b2 are commonly used for the first power supply 1 and the second power supply 2, and the first-phase voltage conversion part 15a1 and the second-phase voltage conversion part 15a2 are used by being dedicated to the first power supply 1. Because of this, transmission of power of the first power supply 1 and the second power supply 2 can be suitably controlled in various modes suitable for characteristics of the first power supply 1 and the second power supply 2, and size reduction, weight reduction, or cost reduction of the voltage conversion unit 3 can be achieved.

Supply of power of the second power supply 2 to the first-phase voltage conversion part 15a1 and the second-phase voltage conversion part 15a2 dedicated to the first power supply 1 or to the non-rechargeable first power supply 1 (fuel cell) can be reliably blocked by a simple circuit configuration having the diode D3.

As a result, protection of the first power supply 1 and power transmission of the first power supply 1 using the first-phase voltage conversion part 15a1 and the second-phase voltage conversion part 15a2 can be achieved with high reliability.

Because power supplies capable of inputting power to the voltage conversion parts 15a1 and 15a2 having the common core Cra match each other (the first power supply 1), unbalanced energization to the respective coils La1 and La2 of the voltage conversion parts 15a1 and 15a2 can be prevented as much as possible.

Likewise, because power supplies capable of inputting power to the voltage conversion parts 15b1 and 15b2 having the common core Crb match each other (both the first power supply 1 and the second power supply 2), unbalanced energization to the respective coils Lb1 and Lb2 of the voltage conversion parts 15b1 and 15b2 can be prevented as much as possible.

As a result, saturation of the cores Cra and Crb can be prevented, and power transmission efficiency in each of the voltage conversion parts 15a1, 15a2, 15b1, and 15b2 can be improved.

Although the core Cra is made common to the voltage conversion parts 15a1 and 15a2 and the core Crb is made common to the voltage conversion parts 15b1 and 15b2 in the above-described embodiment, the voltage conversion parts 15a1 and 15a2 may have separate cores, or the voltage conversion parts 15b1 and 15b2 may have separate cores.

There may be a single or three or more voltage conversion parts that are common to the first power supply 1 and the second power supply 2, and there may be a single or three or more voltage conversion parts dedicated to the first power supply 1.

One or more voltage conversion parts dedicated to the second power supply 2 may be further included.

Although a case in which the electric motor 100 is employed as an electric load is described as an example in the above-described embodiment, the electric load may be an electric actuator or the like other than the electric motor 100.

The first power supply 1 may be a power supply other than a fuel cell, and may be, for example, an electric condenser having a higher capacitance than the second power supply 2. In this case, the first power supply 1 may be a power supply in which charging of regenerative power or charging from the second power supply 2 is prohibited to prevent progress of deterioration thereof as much as possible.

The power supply system of the present invention may be embedded in a transportation apparatus other than a vehicle (for example, a ship, a track vehicle, an aircraft, or the like). Alternatively, the power supply system may be installed in stationary equipment.

What is claimed is:

1. A power supply system comprising:
a first power supply and a second power supply; and
a voltage conversion unit having a first power input part and a second power input part to which power of the first power supply and power of the second power supply are respectively input and a plurality of voltage conversion parts each configured to input power of the first power supply or the second power supply from the first power input part or the second power input part and output power obtained by converting a voltage of the input power, the plurality of voltage conversion parts being connected in parallel to a common power output part so that the plurality of voltage conversion parts are able to output power from the power output part,
wherein the voltage conversion unit is configured to be capable of inputting power of both the first power supply and the second power supply to one or more of the plurality of voltage conversion parts, and the first power supply is configured to be able to input power to a larger number of voltage conversion parts of the plurality of voltage conversion parts than the second power supply.

2. The power supply system according to claim 1, wherein the first power supply and the second power supply are power supplies having different characteristics such that the first power supply has higher energy density than the second power supply and the second power supply has higher output density than the first power supply.

3. The power supply system according to claim 1, wherein the first power supply is a fuel cell, and the second power supply is an electric condenser.

4. The power supply system according to claim 1, wherein the voltage conversion unit is configured so that power of the first power supply is able to be input from the first power input part to all of the plurality of voltage conversion parts.

5. The power supply system according to claim 1, wherein the voltage conversion unit includes one or more pairs of two voltage conversion parts respectively having two coils wound in opposite winding directions in a common core, and the voltage conversion unit is configured that a power supply capable of inputting power to one of the two voltage conversion parts of each pair and a power supply capable of inputting power to the other one match each other.

6. The power supply system according to claim 1, wherein
the voltage conversion unit includes a first-A energization path configured to supply power from the first power input part to the voltage conversion part capable of inputting power of only the first power supply, a first-B energization path configured to supply power from the first power input part to the voltage conversion part capable of inputting power of both the first power supply and the second power supply, and a second energization path configured to supply power from the second power input part to the voltage conversion part capable of inputting power of the second power supply, and
the first-B energization path has a diode for blocking power transmission in a direction opposite to a direction toward the voltage conversion part capable of inputting power of both the first power supply and the second power supply from the first power input part and is connected to the second energization path via the diode so that transmission of power of the second power supply to the first power input part side from the second energization path via the first-B energization path is blocked.

7. The power supply system according to claim 6, wherein the first-B energization path further has a switch element capable of blocking energization in the first-B energization path.

8. The power supply system according to claim 1, wherein
the first power supply is a non-rechargeable power supply or a power supply prohibited from being charged from the power output part side via any one of the plurality of voltage conversion parts,
the second power supply is a rechargeable power supply, and
the voltage conversion part capable of inputting power of only the first power supply is a one-way type voltage conversion part configured to transmit power in only one way from the first power input part side toward the power output part side, and the voltage conversion part capable of inputting power of the second power supply is a two-way type voltage conversion part configured to transmit power in two ways between the second power input part side and the power output part side.

9. The power supply system according to claim 8, wherein the power output part is connected to an electric motor capable of outputting regenerative power.

10. A transportation apparatus comprising the power supply system according to claim 1.
